(19) United States
(12) Patent Application Publication
(10) Pub. No.: US 2024/0243294 A1
(43) Pub. Date: Jul. 18, 2024

(54) CONDUCTIVE MATERIAL DISPERSED SOLUTION, ANODE FOR SECONDARY BATTERY PREPARED USING THE SAME AND SECONDARY BATTERY COMPRISING THE SAME

(71) Applicant: SK ON CO., LTD., Seoul (KR)

(72) Inventor: Byoung Ho KO, Daejeon (KR)

(21) Appl. No.: 18/487,124

(22) Filed: Oct. 16, 2023

(30) Foreign Application Priority Data
Jan. 12, 2023 (KR) 10-2023-0004404

(51) Int. Cl. H01M 4/62; H01M 4/36; H01M 4/38

(52) U.S. Cl. CPC H01M 4/625; H01M 4/366; H01M 4/386; H01M 4/622

(57) ABSTRACT

In an implementation, a conductive material dispersed solution includes: a multi-walled carbon nanotube (MWCNT), a dispersant, and a dispersion medium, wherein a phase angle before 500 s⁻¹ at 1 Hz is 60° or more, and a phase angle after 500 s⁻¹ at 1 Hz is 60° or more, and sheer viscosity at a shear rate of 0.1 s⁻¹ is 4.0 Pa·s or less, and sheer viscosity at a shear rate of 1000 s⁻¹ is 0.05 Pa·s or less.

### CROSS-REFERENCE TO RELATED APPLICATION(S)

This patent document claims the priority and benefits of Korean Patent Application No. 10-2023-0004404 filed on Jan. 12, 2023, the disclosure of which is incorporated herein by reference in its entirety.

### TECHNICAL FIELD

The technology and implementations disclosed in this patent document generally relate to a conductive material dispersed solution, an anode for a secondary battery prepared using the same and a secondary battery comprising the same.

### BACKGROUND

With a recent increase in technological development of and demand for mobile devices, the demand for batteries as an energy source has increased rapidly, and accordingly, various studies on batteries that can meet various demands has been conducted. Specifically, research into lithium secondary batteries having excellent lifespan and cycle characteristics as well as having high energy density as the power source of such devices has been actively conducted.

The lithium secondary battery refers to a battery including a cathode including a cathode active material capable of intercalating and deintercalating lithium ions, an anode including an anode active material capable of intercalating and deintercalating lithium ions, and a non-aqueous electrolyte containing lithium ions in an anode assembly with a microporous separator interposed between the cathode and the anode.

Lithium metal, a lithium alloy, crystalline or amorphous carbon, a carbon composite, and a silicon-based anode active material are used as the anode active material. Thereamong, the silicon-based anode active material, which is the anode active material including silicon (Si), can provide high energy density by improving capacitance of a secondary battery, and is thus used alone or in combination with another anode active material.

### SUMMARY

The disclosed technology can be implemented in an embodiment to provide a conductive material dispersed solution which can prevent the destruction of a conductive path due to decomposition and expansion of a silicon-based anode active material and can improve cycle characteristics when used with the silicon-based anode active material.

The disclosed technology can be implemented in another embodiment to provide an anode prepared using the conductive material dispersed solution and a secondary battery comprising the same.

In an embodiment of the disclosed technology, provided is a conductive material dispersed solution including: a multi-walled carbon nanotube (MWCNT), a dispersant, and a dispersion medium, wherein a phase angle before 500 s⁻¹ at 1 Hz is 60° or more, and a phase angle after 500 s⁻¹ at 1 Hz is 60° or more, and sheer viscosity at a shear rate of 0.1 s⁻¹ is 4.0 Pa·s or less, and sheer viscosity at a shear rate of 1000 s⁻¹ is 0.05 Pa·s or less.

A content of the multi-walled carbon nanotubes may be 1 to 10 wt % based on a total weight of the conductive material dispersed solution.

The multi-walled carbon nanotubes may have an average length of 1 to 200 μm.

The multi-walled carbon nanotubes may have an average diameter of 1 to 20 nm.

A specific surface area of the multi-walled carbon nanotube according to a BET measurement method may be 150 to 250 m²/g.

In another embodiment of the disclosed technology, provided is an anode for a secondary battery including: an anode current collector; a first anode mixture layer provided on at least one surface of the anode current collector; and a second anode mixture layer formed on the first anode mixture layer, wherein each of the first anode mixture layer and the second anode mixture layer may be independently formed of an anode slurry composition including a silicon-based anode active material and the conductive material dispersed solution of claim 1, a content of the silicon-based anode active material is 1 to 5 wt % based on a total weight of the first anode mixture layer and the second anode mixture layer, and a content of the multi-walled carbon nanotubes is 0.35 to 0.6 wt % based on the total weight of the first anode mixture layer and the second anode mixture layer.

The silicon-based anode active material may be at least one kind selected from the group consisting of Si, SiOx (0<x<2), and a SiC composite.

Each of the first anode mixture layer and the second anode mixture layer may independently further include a carbon-based anode active material.

The anode slurry may further include a binder.

A content of the binder may be 1.5 to 3.0 wt % based on a total weight of the first anode mixture layer, and a content of the binder may be 0.1 to 1.0 wt % based on a total weight of the second anode mixture layer.

The binder may be at least one kind selected from the group consisting of SBR and PAA.

Each of the first anode mixture layer and the second anode mixture layer may independently further include at least one kind selected from the group consisting of a conductive material and a thickener except for multi-walled carbon nanotubes.

In another embodiment of the disclosed technology, provided is a secondary battery including: a cathode; the anode for a secondary battery; an electrolyte; and a separator interposed between the cathode and the anode.

A conductive material dispersed solution according to an embodiment may include a specific content of multi-walled carbon nanotubes, thereby preventing destruction of a conductive path due to decomposition and expansion of a silicon-based anode active material.

An anode according to an embodiment may be formed of the conductive material dispersed material described above, thereby improving electrode resistance and cycle characteristics of a secondary battery.

### BRIEF DESCRIPTION OF DRAWINGS

Certain aspects, features, and advantages of the disclosed technology are illustrated by the following detailed description with reference to the accompanying drawings.

FIG. 1 is a graph illustrating a shear rate of a conductive material dispersed solution according to an embodiment.

FIG. 2 is a graph illustrating a phase angle of a conductive material dispersed solution according to an embodiment.

FIG. 3 is a graph illustrating lifespan characteristics of a secondary battery in Examples and Comparative Examples.

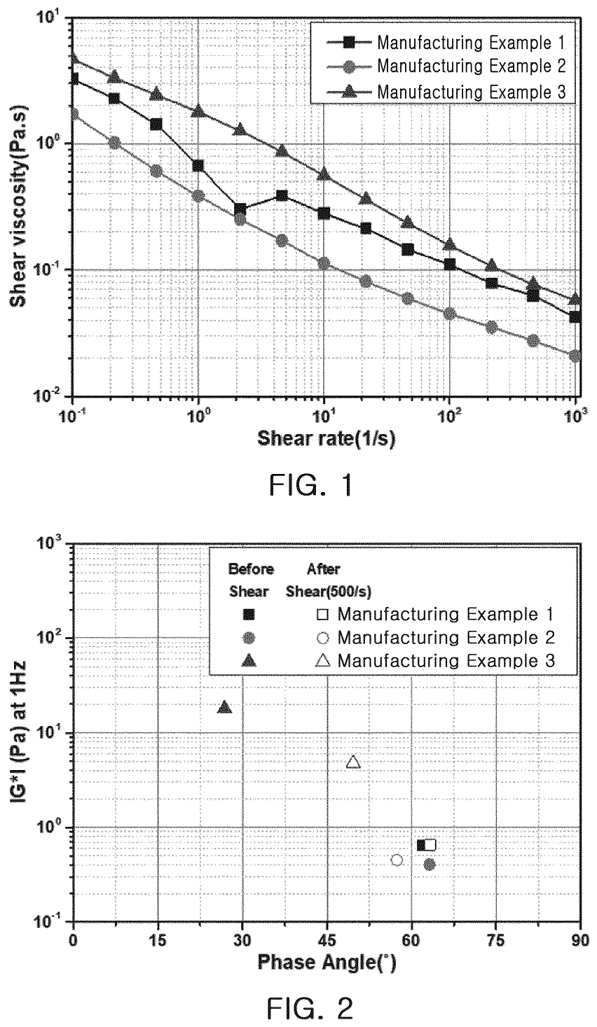

### DETAILED DESCRIPTION

Hereinafter, implementations of an embodiment will be described. However, the implementations of one embodiment may be modified into several different forms, and the scope of an embodiment is not limited to the implementations described below.

### Conductive Material Dispersed Solution

Multi-walled carbon nanotubes included in an anode for a secondary battery have a larger specific surface area than that of a point-type conductive material. Accordingly, a separate pretreatment may be performed to improve the dispersibility of the carbon nanotubes in a slurry for an anode.

Accordingly, according to an embodiment, provided is a conductive material dispersed solution which may prevent destruction of a conductive path due to decomposition and expansion of a silicon-based anode active material, and may improve cycle characteristics of a secondary battery when the conductive material dispersed solution is used together with a certain content of the silicon-based anode active material. The conductive material dispersed solution includes a multi-walled carbon nanotube (MWCNT), a dispersant, and a dispersion medium.

The dispersibility of a conductive material in the conductive material dispersed solution of an embodiment may be expressed using a phase angle, a shear rate, and a complex (shear) modulus by dynamic viscoelasticity measurements.

The phase angle, the shear rate, and the complex (shear) modulus by the dynamic viscoelasticity measurements depend on a concentration of a conductive material in a dispersion. In the case of using carbon nanotubes having a high specific surface area as a conductive material, as a content of the conductive material including the carbon nanotubes decreases, an obtained dispersion approaches a pure viscous material, thus allowing the phase angle to approach 90°. Conversely, a dispersion in which a conductive material including carbon nanotubes is included at a high concentration finds it difficult to disperse the conductive material uniformly.

The phase angle denotes a phase difference between stress waves when deformation applied to the conductive material dispersed solution is used as a sinusoidal wave. In the case of a pure elastic material, since there is a sinusoidal wave having the same phase as that of the applied deformation, the phase angle is 0°. On the other hand, in the case of a pure viscous material, there is a stress wave that has moved at the phase angle of 90°.

In a typical viscoelastic sample, sinusoidal waves having a phase angle greater than 0° and less than 90° are generated. When the dispersibility of the conductive material in the conductive material dispersed solution is proper, the phase angle approaches 90°, which is the pure viscous material.

In the conductive material dispersed solution of an embodiment, the phase angle before 500 s⁻¹ at 1 Hz may be 60° or more, and specifically 61° or more, and the phase angle after 500 s⁻¹ at 1 Hz may be 60° or more, specifically 61° or more, and more specifically 62° or more. An anode slurry prepared using the conductive material dispersed solution having the phase angle having the aforementioned range may be greatly dispersed on a surface of the silicon-based anode active material.

Shear viscosity may be measured using a rheometer in the shear rate ranging from 0.1 to 1000 s⁻¹, and with a decrease in the shear viscosity, the flowability may excellently increase.

The shear viscosity of the conductive material dispersed solution in an embodiment may be 4.0 Pa·s or less, and may be 3.5 Pa·s or less, at the shear rate of 0.1 s⁻¹, and the shear viscosity may be 0.05 Pa·s or less, and may be 0.045 Pa·s or less, at the shear rate of 1000 s⁻¹. The conductive material dispersed solution having the shear rate having the aforementioned range may exhibit excellent dispersion characteristics when applied to prepare an electrode.

A complex modulus or a complex shear modulus of the conductive material dispersed solution of an embodiment is an amount indicative of dynamic viscoelasticity, and denotes a magnitude of elastic energy accumulated in a material, which may be reduced as it changes from solid to liquid. The complex modulus of the conductive material dispersed solution in an embodiment may be measured using a viscosity meter, specifically a rheometer. More specifically, after setting a constant distance between circular rotating plates of the rheometer, a conductive material dispersed solution corresponding to the volume to be filled by the corresponding distance may be added to the rheometer, a range from 10⁻¹ to 10³ may be set while increasing the shear rate by approximately double, and the force generated by rotating the rotating plate may be measured, thus measuring a shear viscosity value.

In the conductive material dispersed solution according to an embodiment, in the case of performing measurements using the rheometer, when a frequency thereof is 1 Hz, the complex modulus (|G*|@1 Hz) is 1 Pa or less before and after the shear rate of 500S⁻¹, specifically 0.8 Pa or less, and more specifically 0.7 Pa or less. The conductive material dispersed solution having a complex modulus having the aforementioned range may be greatly distributed on a surface of the silicon-based anode active material in a process of preparing an anode slurry.

The carbon nanotube is a secondary structure formed by aggregating carbon nanotube units such that carbon nanotube units are fully or partially bundled, and the carbon nanotube unit has graphite sheets in a cylinder shape having nano-sized diameters and has sp² bond structures. In this case, according to the rolling angle and structures of the graphite surface, the carbon nanotube units may represent conductive or semiconductive characteristics. Depending on the number of bonds forming walls, the carbon nanotube units may be classified into single-walled carbon nanotubes (SWCNT), double-walled carbon nanotubes (DWCNT), and multi-walled carbon nanotubes (MWCNT). The carbon nanotube units have lower resistance as the walls thereof are thinner.

In general, the carbon nanotube may have better electrical conductivity and a larger specific surface area as the number of walls is reduced, thus maintaining an electron conduction network between carbon nanotubes. Because of these superior network characteristics, a problem of changing a conductive path due to volume expansion of the silicon-based anode active material, and the problem of defective anode surface, such as peeling from an anode current collector, may be minimized.

However, the single-walled carbon nanotubes and double-walled carbon nanotubes with fewer walls are expensive conductive materials, an anode and a secondary battery including the same have a problem of a rapid increase in manufacturing cost.

Accordingly, the conductive material dispersed solution of an embodiment uses relatively inexpensive multi-walled carbon nanotubes without using the above-described expensive carbon nanotube conductive materials, and specifically, when preparing a slurry for an anode containing a certain content of a silicon-based anode active material, the content of multi-walled carbon nanotubes may be optimized, thereby solving the problems of changing the conductive path due to the volume expansion of the silicon-based anode active material and the problem of defective anode surface, such as peeling from an anode current collector, as well as ensuring the effect of prolonging battery capacity and lifespan.

The content of the multi-walled carbon nanotubes may be 1 to 10 wt % based on the total weight of the conductive material dispersed solution, specifically 2 to 8 wt %, and more specifically 4 to 6 wt %. When the content of the multi-walled carbon nanotubes belongs to the aforementioned range, a balance between electronic conductivity and dispersibility may be improved. When the content of the multi-walled carbon nanotubes is less than 1 wt %, a composition for forming an electrode may include a large amount of organic solvent upon preparing an electrode of a lithium secondary battery, and as a result, the number of voids in the electrodes may increase, and a charging rate of an active material may be lowered, thus reducing the battery capacitance. Furthermore, drying time for removing the organic solvent may be lengthened. Furthermore, when the content of multi-walled carbon nanotubes exceeds 10 wt %, there may be a concern that the mixing dispersibility with the anode active material may be lowered.

The multi-walled carbon nanotubes may have an average length of 1 to 200 μm, and specifically 50 to 200 μm. When the average length of the multi-walled carbon nanotubes is less than 1 μm, because it is difficult to form a conductive path efficiently on the surface of the silicon-based anode active material, the electrical conductivity may be reduced, and when the average length of the multi-walled carbon nanotubes exceeds 200 μm, the dispersibility may be reduced.

The multi-walled carbon nanotubes may have an average diameter of 1 to 20 nm, and specifically 8 to 12 nm. When the average diameter of the multi-walled carbon nanotubes is less than 1 nm, since the dispersion thereof is difficult to perform, processability thereof may decrease, and since the dispersed multi-walled carbon nanotube units or multi-walled carbon nanotubes are buried in a space between anode active material particles, there may be a problem that it may be difficult to form sufficient pores. When the average diameter of the multi-walled carbon nanotubes exceeds 20 nm, the electrical conductivity of the multi-walled carbon nanotubes may be reduced to lower electrode resistance.

The multi-walled carbon nanotube may have a specific surface area (BET) of 150 to 250 m²/g, and specifically 200 to 250 m²/g. The multi-walled carbon nanotubes in the aforementioned range may have excellent dispersibility.

The conductive material dispersed solution of an embodiment includes a dispersant to stabilize the dispersion. The dispersant may include an anionic, nonionic, or cationic surfactant; or a polymer dispersant. The dispersant may be at least one kind selected from the group consisting of, for example, CMC, pyrrolidone (PVP), poly vinyl alcohol (PVA), sodium dodecyl sulfate (SDS), sodium dodecyl benzene sulfate (SDBS), cetyl trimethyl ammonium bromide (STAB), and the like, but the disclosed technology is not particularly limited thereto.

The content of the dispersant based on the total weight of the conductive material dispersed solution may be 0.5 to 3 wt %, specifically 0.5 to 2 wt %, more specifically 1 to 1.8 wt %, and even more specifically 1.4 to 1.6 wt %. When the dispersant belongs to the aforementioned range, the dispersibility of the carbon nanotubes may be improved and the miscibility with the dispersion medium may be improved.

The conductive material dispersed solution may have a solid content of 0.5 to 40 wt %. The solid content of the conductive material dispersed solution refers to a weight of the remaining components except for a solvent based on the total weight of the conductive material dispersed solution.

According to an embodiment, the type of the dispersion medium used for dispersion of the conductive material is not particularly limited, but distilled water may be used.

The content of the dispersion medium based on the total weight of the conductive material dispersed solution may be 92 to 97 wt %, and specifically 93 to 95 wt %. When the dispersion medium belongs to the aforementioned range, it may be possible to ensure appropriate flowability of the conductive material dispersed solution and temporal stability such as sedimentation.

In the conductive material dispersed solution, the solvent may be mixed with the silicon-based anode active material, the carbon-based anode active material, the binder, and, if necessary, the conductive material and the thickener other than the multi-walled carbon nanotubes, thereby preparing an anode slurry composition described below.

### Anode for Secondary Battery

An anode for a secondary battery according to an embodiment is meant to solve a problem of electrode surface defects caused by a volume change caused by contraction and expansion of a silicon-based anode active material, in preparing the anode for a secondary battery including the silicon-based anode active material, and accordingly, an aspect of the disclosed technology is to provide an anode for a secondary battery including an anode mixture layer formed of an anode slurry composition including a silicon-based anode active material and the conductive material dispersed solution described above.

Specifically, an anode according to an embodiment provides a multilayer anode in which an anode mixture layer formed of an anode slurry composition including a silicon-based anode active material and the aforementioned conductive material dispersed solution has a multilayer structure on a surface of an anode current collector.

The anode current collector is not particularly limited as long as the anode current collector has high conductivity without causing a chemical change in a battery. Specifically, for the anode current collector, copper, stainless steel, nickel, titanium, sintered carbon, a copper or stainless steel surface treated with carbon, nickel, titanium, silver, etc., or aluminum-cadmium alloys may be used.

The anode current collector with a thickness of 3 μm to 100 μm may be typically used. Specifically, the anode current collector may have a thickness of 4 μm to 40 μm to implement a thin anode. Furthermore, fine unevenness may be formed on a surface of the cathode current collector, thus strengthening bonding force of the anode active material. For example, the anode current collector may be used in various forms such as a film, a sheet, a foil, a net, a porous material, a foam, a non-woven fabric, and the like.

An anode for a secondary battery of an embodiment may include a plurality of anode mixture layers on one surface or both surfaces of the anode current collector. The anode mixture layer is not particularly limited, but may be two or more layers. Specifically, the anode mixture layer includes a first anode mixture layer formed on an upper surface of the anode current collector, and a second anode mixture layer on the first anode mixture layer.

Each of the anode mixture layers may be formed of an anode slurry composition, and the anode slurry composition may include a silicon-based anode active material and the aforementioned conductive material dispersed solution, and, in addition to the silicon-based anode active material and the multi-walled carbon nanotube (MWCNT), the anode slurry composition may further a conductive material and a thickener in addition to a binder, a carbon-based anode active material and a multi-walled carbon nanotube, generally used for an anode for a secondary battery.

A content of the silicon-based anode active material based on a total weight of the first anode mixture layer and the second anode mixture layer may be 1 to 5 wt %, and specifically 3 to 5 wt %. When the content of the silicon-based anode active material belongs in the aforementioned range, the secondary battery may be repeatedly charged and discharged, which may cause a volume of the silicon-based anode active material to shrink or expand. However, when the content thereof is applied in a content range of multi-walled carbon nanotubes described below, a stable conductive path may be maintained.

The silicon-based anode active material included in the first anode mixture layer and the second anode mixture layer, that is, silicon-containing anode active materials included in each layer may be included to have the same content as they move away from the anode current collector in a thickness direction toward a surface of the anode. The content of an applied conductive material may vary, depending on the content of the silicon-based anode active material, and when the contents of the silicon-based anode active material applied to the first anode mixture layer and the second anode mixture layer are significantly different from each other, a difference in the weight of a solid content of the slurry may occur due to the difference between the contents of the conductive material. Accordingly, when the difference between concentrations of the slurry is increased upon preparing the first anode mixture layer and the second anode mixture layer, a migration effect may be accelerated during a drying process, resulting in a possibility that the distribution of the binder and the conductive material in the anode may become non-uniform.

The silicon-based anode active material included in the anode active material for a secondary battery according to an embodiment may intercalate and deintercalate lithium ions, and is no particularly limited as long as the silicon-based anode active material includes Si, and for example, the silicon-based anode active material may include, for example, Si, SiOx (0<x<2), a SiC composite, Si alloys.

Since SiO₂ does not react with the lithium ions and thus may not store lithium, x may be within the above-described range. Furthermore, the Si alloy is a Si-Q alloy, and the Q may be an element selected from the group consisting of alkali metals, alkaline earth metals, Group 13 elements, Group 14 elements, Group 15 elements, Group 16 elements, transition metals, rare earth elements, and combinations thereof, other than Si, and specifically, the Q may be an element selected from the group consisting of Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and combinations thereof.

The silicon-based anode active material is not particularly limited, but an average particle diameter (D₅₀) may be 1 μm to 10 μm, and specifically 4 μm to 7 μm. When the particle diameter of the silicon-based anode active material satisfies the aforementioned range, structural stability of the active material may be achieved during charging and discharging, and a conductive network for maintaining electrical conductivity may be formed more smoothly, and also, it may be possible to facilitate access to a binder for binding between the active materials or between the active material and the current collector.

The first anode mixture layer and the second anode mixture layer are formed of the conductive material dispersed solution described above, and include multi-walled carbon nanotubes. The content of the multi-walled carbon nanotubes based on the total weight of the first anode mixture layer and the second anode mixture layer may be 0.35 to 0.6 wt %, specifically 0.35 to 0.55 wt %, and more specifically 0.38 to 0.54 wt %. When the multi-walled carbon nanotubes belong to the aforementioned range, better capacitance retention may be exhibited than when a graphite-based conductive agent is applied in an application composition of 5 wt % or less of the silicon-based anode active material, and even if single-walled carbon nanotubes or double-walled carbon nanotubes are not used, a stable conductive path for expansion of the silicon-based anode active material due to repeated charging and discharging may be maintained even with a multi-walled carbon nanotube conductive material, thereby obtaining excellent battery lifespan.

The contents of the multi-walled carbon nanotubes included in the first anode mixture layer and the second anode mixture layer may be increased or may be identical as a distance from the anode current collector in the thickness direction increases toward the surface of the anode, and specifically, the same content may be included.

The anode for a secondary battery of an embodiment may further include a binder. The binder may serve to attach anode active material particles to each other and also to attach the anode active material to the anode current collector, and a commonly used binder may be used. Examples of the binder may include polyvinyl alcohol, carboxymethyl cellulose, hydroxypropyl cellulose, diacetyl cellulose, polyvinyl chloride, carboxylated polyvinyl chloride, polyvinylfluoride, polymers containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber (SBR), polyacrylic acid (PAA), an epoxy resin, nylon, and the disclosed technology is not limited thereto.

The binder is independently included in the first anode mixture layer and the second anode mixture layer, respectively, and the contents of the binders included in each layer may be increased or may be identical as the distance from the anode current collector in the thickness direction increases toward the surface of the anode, and specifically, the contents may increase as the distance toward the surface of the anode increases.

The content of the binder based on the total weight of the first anode mixture layer may be 1.5 to 3.0 wt %, and specifically 2.0 to 2.8 wt %, and the content of the binder based on the total weight of the second anode mixture layer may be 0.1 to 1.0 wt %, and specifically 0.2 to 0.8 wt %. When the content of the binder belongs to the aforementioned range, the binder content of the first anode mixture layer is in excess more than an average binder content of all anode mixture layers, thereby achieving adhesion force by complementing migration effects occurring during drying of an electrode. Furthermore, since the binder content of the second anode mixture layer is less than the average binder content thereof, it may be advantageous to secure pores in the electrode, thereby improving resistance.

An anode of an embodiment may further include a thickener for imparting viscosity. Examples of thickeners may include cellulose-based compounds, and may specifically include carboxymethyl cellulose, hydroxypropyl methyl cellulose, methyl cellulose, or alkali metal salts thereof. Na, K, or Li may be used as the alkali metal.

In an anode for a secondary battery of an embodiment, a thickness ratio of each anode mixture layer is not particularly limited, and complies with the L.W (mg/cm²) ratio of each cathode mixture layer. More specifically, the thicknesses of the first anode mixture layer and the second anode mixture layer may not be identical to each other, and for example, while satisfying the above-described relationship, the thickness ratio may be 1:2 to 1:3.

The anode active material may be suitably used in an embodiment as long as the anode active material has a function of intercalating and deintercalating lithium ions. For example, the anode active material may further include carbon-based active materials, and for the anode active material, amorphous, plate, flake, spherical or fibrous natural graphite or artificial graphite may be used, and artificial graphite and natural graphite may be mixed and used. When the artificial graphite and the natural graphite are mixed and used, there is no particular limitation, but the artificial graphite and the natural graphite may be mixed in a weight ratio of, for example, 70:30 to 95:5. Furthermore, the carbon-based active material may be amorphous carbons such as crystalline carbon, soft carbon, or hard carbon, or combinations thereof.

Furthermore, the anode active material may further include at least one of a tin (Sn)-based anode active material or a lithium vanadium oxide anode active material. The Sn-based anode active material may be Sn, SnO₂, or Sn—R alloys. In the Sn—R alloys, the R may be an element selected from the group consisting of alkali metals, alkaline earth metals, Group 13 elements, Group 14 elements, Group 15 elements, Group 16 elements, transition metals, rare earth elements, and combinations thereof, other than Sn and Si, and specifically, the R may be an element selected from the group consisting of Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, In, Tl, Ge, P, As, Sb, Bi, S, Se, Te, Po, and combinations thereof.

When the anode active material further includes the Sn-based anode active material, the Sn-based anode active material may be included in the range of 1 to 50 wt % based on the total weight of the anode active material.

The content of the anode active material in the anode mixture layer of the anode for a secondary battery according to an embodiment may be 94 to 98 wt % based on the total weight of the anode mixture layer.

The conductive material other than the multi-walled carbon nanotubes described above is used to impart conductivity to the electrode, and may be used without any limitation as long as it is commonly used in the secondary battery, and for example, the materials of the conductive material may include carbon-based materials such as natural graphite, artificial graphite, carbon black, acetylene black, and Ketjen black; metal-based materials such as metal powder particles or metal fibers of copper, nickel, aluminum silver, and the like; conductive polymers such as polyphenylene derivatives; or a conductive material including mixtures thereof.

The anode for a secondary battery in an embodiment may be prepared by applying the above-described anode slurry to one surface or both surfaces of the anode current collector, and then drying and roll pressing the anode current collector.

Specifically, in preparing an electrode by manufacturing each slurry for forming each of the anode mixture layers, applying the slurries to the anode current collector, and drying and roll pressing the anode current collector, an anode slurry for forming the first anode mixture layer may be applied and dried, and then, an anode slurry composition for forming the second anode mixture layer may be applied, dried and then roll pressed, thus preparing an anode, and each anode slurry composition may be continuously or intermittently applied, and simultaneously dried, and roll pressed, thereby preparing an anode.

In a case in which the anode is prepared by individually applying and drying the anode slurry compositions as described above to form each anode mixture layer, during the drying process, migration phenomena such as binders may be suppressed, and in a case in which each anode slurry is applied and dried at the same time, the process may be simplified.

A method of applying the anode slurry composition is not particularly limited and may be performed by a known manner. For example, after distributing the anode slurry over the anode current collector, the anode slurry may be uniformly dispersed using a doctor blade or the like. In some cases, a method of performing distribution and dispersion processes in one process may be used. Furthermore, methods such as die casting, comma coating, gravure coating, and screen-printing may be applied.

### Secondary Battery

A secondary battery of an embodiment may include a cathode: the anode for a secondary battery described above; an electrolyte; and a separator interposed between the cathode and the anode.

The cathode is not particularly limited, and a cathode active material may include lithium-transition metal oxides such as lithium cobalt oxide (LiCoO₂), lithium manganese oxide (LiMn₂O₄), or lithium nickel oxide (LiNiO₂), or lithium-transition metal composite oxides in which some of these transition metals are substituted with other transition metals. Specifically, the lithium-transition metal composite oxide may be an NCM-based cathode active material represented by the chemical formula of LiₓNiₐCo_{b}Mn_{c}Al_{d}O_{y}(0<x≤1.1, 2≤y≤2.02, 0<a<1, 0<b<1, 0<c<1, 0<d<1, 0<a+b+c+d≤1). Furthermore, the cathode active material may be a lithium iron phosphate (LFP)-based cathode active material represented by the chemical formula of LiFePO₄.

Examples of the electrolyte may include an organic liquid electrolyte, an inorganic liquid electrolyte, a solid polymer electrolyte, a gel polymer electrolyte, a solid inorganic electrolyte, and a molten inorganic electrolyte, which can be used to prepare a secondary battery, but the disclosed technology is not limited thereto.

The separator may separate an anode and a cathode and provide a moving path for lithium ions, and the separator may be used without any particular limitation as long as it is usually used as a separator in a common secondary battery, and specifically, the separator may have low resistance to ion migration of the electrolyte and excellent electrolyte-moisturizing ability. Specifically, examples of the separator may include porous polymer films made of polyolefin-based polymers such as ethylene monopolymers, propylene monopolymers, ethylene/butene copolymers, ethylene/hexene copolymers and ethylene/methacrylate copolymers, or a stacked structure of two or more layers of these films. Furthermore, examples of the separator may further include conventional porous nonwoven fabrics such as glass fibers with high melting points and polyethylene terephthalate fibers. Furthermore, in order to ensure heat resistance or mechanical strength, a coated separator including ceramic components or polymeric materials may also be used, and the separator may optionally have a single layer or multilayer structure.

### Example

Hereinafter, embodiments of the present disclosure will be further described with reference to specific experimental examples. Examples and comparative examples included in the experimental examples are merely illustrative of the present disclosure and do not limit the scope of the accompanying claims, and it is apparent to those skilled in the art to which the present disclosure belongs that various changes or modifications may be made within the concept and scope of the present disclosure, and thus it will be revealed that such changes or modifications fall within the appended claims.

### Manufacturing Example

### 1. Manufacturing of Conductive Material Dispersed Solution

### (1) MWCNT Dispersed Solution

As a bundle-type MWCNT (average strand diameter=12 nm) dispersant, polyvinylpyrrolidone and distilled water of the remainder were added at a content ratio shown in Table 1 below and were mixed with a homogeneous mixer at 2000 rpm for 30 minutes, and passed with 5-pass using a high-pressure disperser (Micronox MN400BF), thereby obtaining the MWCNT dispersed solution of Table 1 below.

| | Solid | MWCNT | Dispersant | MWCNT |
|---|---|---|---|---|
| | Content | Content | Content | Content/Solid |
| | (wt %) | (wt %) | (wt %) | Content |
| Manufacturing | 6.5 | 5 | 1.5 | 0.769 |
| Example 1 | | | | |
| Manufacturing | 6 | 5 | 1 | 0.833 |
| Example 2 | | | | |
| Manufacturing | 6.35 | 5 | 1.35 | 0.787 |
| Example 3 | | | | |

### (2) G10 Comparative Manufacturing Example

G10 (graphite-based conductive agent) was used in the form of powder particles.

### 2. Manufacturing of Anode for Secondary Battery

A first anode mixture layer composition (lower layer) in a slurry form in which MWCNT was included in the amount shown in Table 2 below was manufactured by including 90.7 wt % of a carbon-based anode active material (artificial=100), 5 wt % of SiOx, 1.2 wt % of CMC, 2.6 wt % of SBR, the above-described conductive material dispersed solution and the remaining water.

Furthermore, except that 0.4 wt % of the SBR is provided and the remaining water is further included, a second cathode mixture layer composition (upper layer) was prepared by including the same composition as the above-described composition of the first anode mixture layer composition slurry.

The manufactured anode mixture layer composition was differently applied as shown in Table 2 below to prepare an anode having a double-layer structure.

However, in Comparative Example 6 below, a single-layer anode was prepared using an anode mixture layer composition in a slurry form manufactured by including 91.8 wt % of a carbon-based anode active material (artificial=10), 5 wt % of a SiOx silicon-based anode active material, 1.2 wt % of CMC, 1.5 wt % of SBR, and 0.5 wt % of the conductive material dispersed solution of Manufacturing Example 1.

TABLE 2

| | | Type of | | | | | |
|---|---|---|---|---|---|---|---|
| | | Conductive | | SBR content | | Solid Content | |
| | | Material | MWCNT | (wt %) | | (wt %) | |
| | Coating | Dispersed | content | Upper | Lower | Upper | Lower |
| | manner | Solution | (wt %) | layer | layer | layer | layer |
| Example 1 | Double | Manufacturing | 0.385 | 0.4 | 2.6 | 48.4 | 48.15 |
| | layer | Example 1 | | | | | |
| Example 2 | Double | Manufacturing | 0.462 | 0.4 | 2.6 | 48.09 | 47.84 |
| | layer | Example 1 | | | | | |
| Example 3 | Double | Manufacturing | 0.538 | 0.4 | 2.6 | 47.78 | 47.54 |
| | layer | Example 1 | | | | | |
| Comparative | Double | Manufacturing | 0.231 | 0.4 | 2.6 | 49.04 | 48.78 |
| Example 1 | layer | Example 1 | | | | | |
| Comparative | Double | Manufacturing | 0.308 | 0.4 | 2.6 | 48.72 | 48.46 |
| Example 2 | layer | Example 1 | | | | | |
| Comparative | Double | Manufacturing | 0.394 | 0.4 | 2.6 | 48.25 | 48 |
| Example 3 | layer | Example 2 | | | | | |
| Comparative | Double | Manufacturing | 0.417 | 0.4 | 2.6 | 48.36 | 48.11 |
| Example 4 | layer | Example 3 | | | | | |
| Comparative | Double | Comparative | — | 0.4 | 2.6 | 50.15 | 49.33 |
| Example 5 | layer | Manufacturing | | | | | |
| | | Example | | | | | |
| Comparative | Single | Manufacturing | 0.385 | 1.5 | | 48.28 | |
| Example 6 | layer | Example 1 | | | | | |

### 3. Manufacturing of Secondary Battery

A cathode slurry was manufactured by mixing Li [Ni_{0.88}Co_{0.1}Mn_{0.02}]O₂ as a cathode active material, MWCNT as a conductive material, and polyvinylidene fluoride (PVdF) as a binder at a weight ratio of 98.28:0.72:1.0. The cathode slurry was uniformly applied to an aluminum foil having a thickness of 12 μm, and was vacuum-dried to prepare a cathode for a secondary battery. In this case, about 20 wt % of the MWCNT content was comprised of a CNT dispersant.

The above-described cathode and anodes of Examples 1 to 3 and Comparative Examples 1 to 6 were circularly punched into sizes of 14 Φ and 16 Φ, respectively, and in a coin cell case, a separator (polyethylene, having a thickness of 13 μm) were sequentially stacked between the cathode and the anode, and the coin cell case was clamped by injecting an electrolyte and then was impregnated for more than an hour.

The electrolyte was manufactured by dissolving 1.1 M LiPF6 in a mixed solvent of EC/EMC (25/75; a volume ratio) and then adding 8 wt % of fluoroethylene carbonate (FEC), 0.5 wt % of 1,3-propensultone (PRS), and 1.0 wt % of 1,3-propanesultone (PS) thereto.

Then, after more than 12 hours of stabilization, a chemical charging-discharging process was performed three times (charging condition CC-CV 0.1C 4.2V 0.05C CUT-OFF, and discharging condition CC 0.1C 2.5V CUTOFF).

Then, standard charging and discharging was performed (charging condition CC-CV 0.3 C 4.2 V 0.05 C CUT-OFF, and discharging condition CC 0.5 C 2.5 V CUT-OFF).

### Evaluation Example

### 1. Sheer Rate Measurement

With respect to conductive material dispersed solutions of Manufacturing Examples 1 to 3 above, a shear rate thereof was increased by approximately double using Malvern's Kinexus rotary equipment, and shear viscosity thereof was simultaneously measured in the range of 10⁻¹ S⁻¹ to 10³ S⁻¹, which is shown in Table 3 and FIG. 2.

### 2. Phase Angle and Complex Modulus Measurement

With respect to conductive material dispersed solutions of Manufacturing Examples 1 to 3 above, after a distance between circular rotating plates of a rheometer (model name: Kinxus rotary type, manufacturer: Malvern) as measuring equipment was set to be uniform, the rheometer was inserted into each of the conductive material dispersed solutions corresponding to a volume filling the corresponding distance, and an amplitude thereof was increased by approximately double and was set to a range from 10⁻² Hz to 10² Hz, thus measuring the phase angle and the complex modulus, and the results at 1 Hz are shown in Table 3 below.

### 3. Measurement of Electrode Resistance

With respect to secondary batteries of Examples 1 to 3 and Comparative Examples 1 to 6 above, electrode resistance thereof was measured in a 4-probe method, and the results thereof are shown in Table 4 below.

### 4. Capacitance Retention Measurement

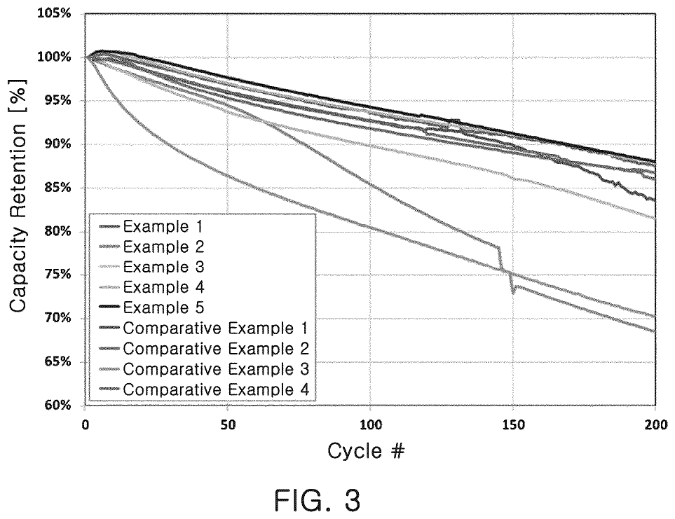

With respect to secondary batteries of Examples 1 to 3 and Comparative Examples 1 to 6, at a temperature of 25° C., a charging C-Rate thereof was set to 0.3C, and a discharging C-Rate thereof was set to 0.5C, and a capacitance retention rate (%) at 200 cycles was evaluated, and accordingly, the results thereof are shown in Table 4 and FIG. 3 below.

TABLE 3

| | | | | | | Phase angle (°) | | Complex Modulus (Pa) | |
|---|---|---|---|---|---|---|---|---|---|
| | Shear Viscosity (Pa · s) | | | | | Before | After | Before | After |
| | 0.1 s⁻¹ | 1 s⁻¹ | 10 s⁻¹ | 100 s⁻¹ | 1000 s⁻¹ | 500 s⁻¹ | 500 s⁻¹ | 500 s⁻¹ | 500 s⁻¹ |
| Manufacturing | 3.244 | 0.669 | 0.282 | 0.110 | 0.042 | 61.9 | 63.3 | 0.646 | 0.651 |
| Example 1 | | | | | | | | | |
| Manufacturing | 1.704 | 0.386 | 0.112 | 0.045 | 0.021 | 63.2 | 57.4 | 0.403 | 0.453 |
| Example 2 | | | | | | | | | |
| Manufacturing | 4.670 | 1.780 | 0.561 | 0.156 | 0.057 | 26.8 | 49.6 | 17.98 | 4.72 |
| Example 3 | | | | | | | | | |

Referring to Table 3 above, in the case of Manufacturing Example 1, the shear viscosity at 0.1S⁻¹ is 4.0 Pa·s or less, the shear viscosity at 1000^{S-1} is 0.05 Pa·s or less, the phase angle before 500S⁻¹ is 60° or more and the phase angle after 500S⁻¹ is 60° or more, and the complex modulus is 1 Pa or less, to lead to excellent flowability of the dispersed solution, which represents a phase angle value where viscosity dominates over elasticity.

Meanwhile, in the case of Manufacturing Example 2, the shear viscosity at 0.1S⁻¹ is 4.0 Pa·s or less, the shear viscosity at 1000S⁻¹ is 0.05 Pa·s or less, and the complex modulus is 1 Pa or less, to lead to excellent flowability of the dispersion, and the phase angle before/after 500S⁻¹ is 45° or more, from which viscosity dominates over elasticity, but the phase angle after 500S⁻¹ is less than 60°, which may have lower viscosity than that of Manufacturing Example 1.

Furthermore, in the case of Manufacturing Example 3, the shear viscosity is high, the complex modulus exceeds 1 Pa, and the phase angle is low, which may cause a problem in which elasticity is dominant compared to viscosity.

TABLE 4

| | Electrode | 200 cycle |
|---|---|---|
| | Resistance | capacitance |
| | (Ω · cm) | retention rate (%) |
| Example 1 | 0.11 | 87.70 |
| Example 2 | 0.09 | 87.80 |
| Example 3 | 0.08 | 88.00 |
| Comparative Example 1 | 0.38 | 68.50 |
| Comparative Example 2 | 0.19 | 81.50 |
| Comparative Example 3 | 0.11 | 83.60 |
| Comparative Example 4 | 0.12 | 86.70 |
| Comparative Example 5 | 0.27 | 70.30 |
| Comparative Example 6 | 0.15 | 86.10 |

Referring to Table 4 above, it may be found that Examples 1 to 3 had low electrode resistance and had excellent 200 cycle capacitance retention rate.

Meanwhile, it may be found that since Comparative Examples 1 and 2 had a lower content of MWCNT than that of the silicon-based anode active material, the electrode resistance and 200 cycle capacitance retention rate were inferior.

In Comparative Examples 3 and 4, the electrode resistance and battery performance difference depending on the composition (CNT/dispersant content) of the used conductive material dispersed solution may be confirmed using the anodes prepared using the conductive material dispersion solutions of Manufacturing Example 2 and Manufacturing Example 3, respectively.

In Comparative Example 5, it may be found that a graphite-based conductive material was applied to have high electrode resistance, and it was difficult to maintain a conductive path according to the expansion of the silicon-based anode active material after repeated charging and discharging, so that the 200 cycle capacitance retention rate was low

In Comparative Example 6, it may be found that since the single-layer coating was applied, a binder migration effect in the drying process was greater than that of the double-layer coating method, and accordingly, in comparison with Example 1, it may be found that the electrode resistance was high and the 200 cycle capacitance retention rate was relatively low.

The above description is merely an example of applying the principle of the present disclosure, and other configurations may be further included within the scope of the present disclosure.

What is claimed is:

1. A conductive material dispersed solution comprising: a multi-walled carbon nanotube (MWCNT), a dispersant, and a dispersion medium,
wherein a phase angle before 500 s⁻¹ at 1 Hz is 60° or more, and a phase angle after 500 s⁻¹ at 1 Hz is 60° or more, and
sheer viscosity at a shear rate of 0.1 s⁻¹ is 4.0 Pa·s or less, and sheer viscosity at a shear rate of 1000 s⁻¹ is 0.05 Pa·s or less.

2. The conductive material dispersed solution of claim 1, wherein a content of the multi-walled carbon nanotubes is 1 to 10 wt % based on a total weight of the conductive material dispersed solution.

3. The conductive material dispersed solution of claim 1, wherein the multi-walled carbon nanotubes have an average length of 1 to 200 μm.

4. The conductive material dispersed solution of claim 1, wherein the multi-walled carbon nanotubes have an average diameter of 1 to 20 nm.

5. The conductive material dispersed solution of claim 1, wherein a specific surface area of the multi-walled carbon nanotube according to a BET measurement method is 150 to 250 m²/g.

6. An anode for a secondary battery comprising:
an anode current collector;
a first anode mixture layer provided on at least one surface of the anode current collector; and
a second anode mixture layer formed on the first anode mixture layer,
wherein each of the first anode mixture layer and the second anode mixture layer is independently formed of an anode slurry composition including a silicon-based anode active material and the conductive material dispersed solution of claim 1,
a content of the silicon-based anode active material is 1 to 5 wt % based on a total weight of the first anode mixture layer and the second anode mixture layer, and
a content of the multi-walled carbon nanotubes is 0.35 to 0.6 wt % based on the total weight of the first anode mixture layer and the second anode mixture layer.

7. The anode for a secondary battery of claim 6, wherein the silicon-based anode active material is at least one kind selected from the group consisting of Si, SiOx (0<x<2), and a SiC composite.

8. The anode for a secondary battery of claim 6, wherein each of the first anode mixture layer and the second anode mixture layer independently further includes a carbon-based anode active material.

9. The anode for a secondary battery of claim 6, wherein the anode slurry further includes a binder.

10. The anode for a secondary battery of claim 9, wherein a content of the binder based on a total weight of the first anode mixture layer is 1.5 to 3.0 wt %, and
a content of the binder based on a total weight of the second anode mixture layer is 0.1 to 1.0 wt %.

11. The anode for a secondary battery of claim 9, wherein the binder is at least one kind selected from the group consisting of SBR and PAA.

12. The anode for a secondary battery of claim 6, wherein each of the first anode mixture layer and the second anode mixture layer independently further includes at least one kind selected from the group consisting of a conductive material and a thickener except for multi-walled carbon nanotubes.

13. A secondary battery comprising:
a cathode;
an anode for a secondary battery of claim 6;
an electrolyte; and
a separator interposed between the cathode and the anode.
